(19) United States
(12) Patent Application Publication
(10) Pub. No.: US 2026/0122440 A1
(43) Pub. Date: Apr. 30, 2026

(54) Audio Capability Discovery

(71) Applicant: Dell Products L.P., Round Rock, TX (US)

(72) Inventors: Kearson M. Mcnulty, Austin, TX (US); David Allen Dyson, Pflugerville, TX (US); Walter Kemp, Georgetown, TX (US)

(73) Assignee: Dell Products L.P., Round Rock, TX (US)

(21) Appl. No.: 18/932,518

(22) Filed: Oct. 30, 2024

(51) Int. Cl. H04S 7/00; G10K 11/178

(52) U.S. Cl. CPC H04S 7/301; G10K 11/17825; H04S 2400/09

(57) ABSTRACT

An Information Handling System (IHS) provides audio spatial notifications through an audio environment agent. The agent identifies microphones and audio playback devices, creating sensitivity and range profiles. Diagnostic sound waves identify acoustic characteristics such as occlusions, distortions, and echoes. The system automatically alters speaker outputs to modify audio within the environment, optimizing spatial separation for notifications. The method includes executing an operating system with the agent, identifying audio components, and producing diagnostic sound waves. The system modifies audio signals to create acoustic separation between notifications and other audio content, enhancing user awareness of notification sources.

### BACKGROUND

Desktop and laptop computers generate sounds through a combination of hardware and software components, enabling them to play sounds produced by applications. Applications such as music players, video games, or system notifications generate sound signals, which are typically in the form of digital audio data. This data is represented as a series of numbers that encode sound waves. The computer's operating system manages the applications'requests to play sounds, usually through an audio driver. The digital audio data is processed by the computer's sound card or other audio interface. This card converts the digital signals into analog signals that can be played by speakers or headphones. Many modern motherboards have integrated sound cards, while some high-performance systems use dedicated sound cards for better audio quality. At the core of the sound card is a Digital-to-Analog Converter (DAC) that transforms the digital signal (ones and zeros) into an analog signal (a continuous waveform). This process is necessary because speakers and headphones require analog signals to produce sound. The analog signal generated by the DAC is then sent to external or built-in speakers or headphones, where it vibrates a diaphragm to create sound waves. These sound waves are interpreted by the human ear as music, voice, or other audio.

### SUMMARY

In an example embodiment, an Information Handling System (IHS) for providing audio spatial notifications comprises at least one processor configured to execute an operating system (OS) and one or more applications, including an audio environment agent. The agent identifies all microphones and audio playback devices attached to the IHS, creates profiles of the sensitivity and range of the microphones, creates profiles of the range of the audio playback devices, produces diagnostic sound waves to identify acoustic characteristics of an environment near the IHS, and automatically alters one or more speaker output to modify audio within the environment. The audio playback devices include one or more of an internal speaker, an external speaker, a soundbar, a subwoofer, a center-channel speaker, headphones, a passive speaker, and an active speaker.

The diagnostic sound waves comprise one or more of high frequency signals, low frequency signals, and white noise. According to another aspect, the high frequency signals are transmitted at a highest frequency possible for the speakers, the low frequency signals are transmitted at a lowest frequency possible for the speakers, and the white noise is broadcast in a frequency range between 85 Hz to 255 Hz.

According to another aspect, the acoustic characteristics of the environment comprise one or more of occlusions, distortions, and echoes. The speaker output may be altered by adjusting a volume, a pitch, or a balance of an audio signal sent to the speaker output. According to another aspect, the audio within the environment is modified by removing occlusions, distortions, and echoes created by the environment.

According to another aspect, the audio within the environment is modified by adjusting system notifications transmitted to the speakers. The audio within the environment may be modified by adjusting panning of system notifications transmitted to the speakers. The one or more speaker output may be altered to modify system notifications while leaving other audio settings unmodified.

According to another aspect, the agent is further configured to compare the profiles of the microphones and the audio playback devices to previously created microphone and speaker profiles.

In another embodiment, a method for optimizing audio playback for notifications in an Information Handling System (IHS) comprises executing, by at least one processor, an operating system (OS) having an audio environment agent. The method identifies all microphones and audio playback devices attached to the IHS, creates sensitivity and range profiles for each of the identified microphones, creates range profiles for each of the identified audio playback devices, produces diagnostic sound waves to discover an acoustic environment near the IHS, and modifies audio signals sent to the audio playback devices to create an acoustic separation between notifications and other audio content.

The diagnostic sound waves comprise one or more of high frequency signals, low frequency signals, and white noise. According to another aspect, the high frequency signals are transmitted at a highest frequency possible for the speakers, the low frequency signals are transmitted at a lowest frequency possible for the speakers, and the white noise is broadcast in a frequency range between 85 Hz to 255 Hz.

According to another aspect, the acoustic characteristics of the environment comprise one or more of occlusions, distortions, and echoes. The speaker output is altered by adjusting a volume, a pitch, or a balance of an audio signal sent to the speaker output. The audio within the environment is modified by removing occlusions, distortions, and echoes created by the environment.

According to another aspect, the audio within the environment is modified by adjusting panning of system notifications transmitted to the speakers.

According to another aspect, the one or more speaker output is altered to modify system notifications while leaving other audio settings unmodified.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram illustrating an embodiment of an Information Handling System for use with audio spatial panning.

FIG. 2 illustrates an example embodiment of a workstation that may be used for automatic audio capability discovery.

FIG. 3 is a flowchart 300 illustrating an example process for audio capability discovery in an IHS and for optimizing acoustic components in the IHS.

FIG. 4 is a block diagram illustrating components of a system for discovering audio capabilities for spatial notifications.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

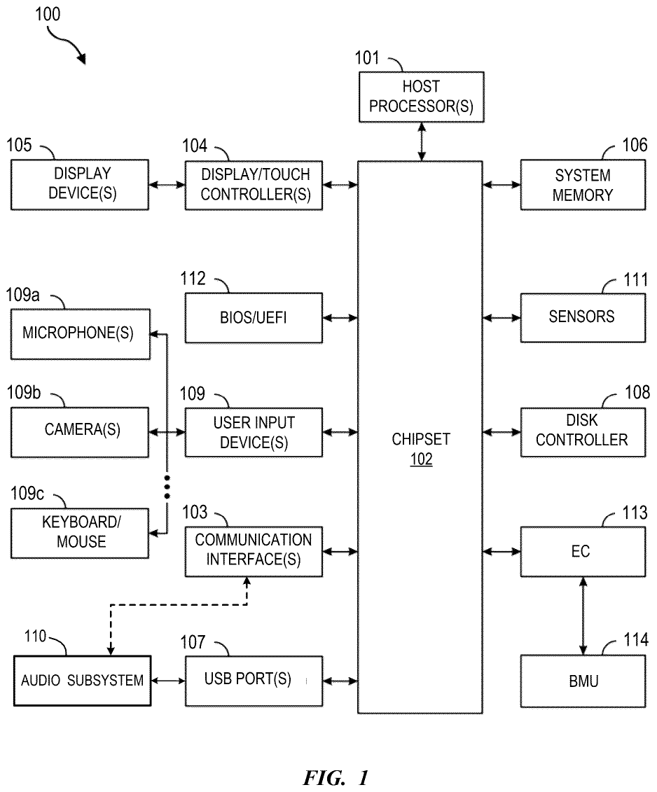

FIG. 1 is a block diagram illustrating an embodiment of an IHS 100. As depicted, IHS 100 includes host processor(s) 101. In various embodiments, IHS 100 may be a single-processor system, or a multi-processor system including two or more processors. Host processor(s) 101 may include any processor capable of executing program instructions, such as an INTEL/AMD x76 processor, or any general-purpose or embedded processor implementing any of a variety of Instruction Set Architectures (ISAs), such as a Complex Instruction Set Computer (CISC) ISA, a Reduced Instruction Set Computer (RISC) ISA (e.g., one or more ARM core(s), or the like).

IHS 100 includes chipset 102 coupled to host processor(s) 101. Chipset 102 may provide host processor(s) 101 with access to resources. In some cases, chipset 102 may utilize a QuickPath Interconnect (QPI) bus to communicate with host processor(s) 101. Chipset 102 may also be coupled to communication interface(s) 103 to enable communications between IHS 100 and various wired and/or wireless networks, such as Ethernet, WiFi (IEEE 802.11), Bluetooth® (IEEE 802.15.1), cellular or mobile networks (e.g., Code-Division Multiple Access or “CDMA,” Time-Division Multiple Access or “TDMA,” Long-Term Evolution or “LTE,” etc.), satellite networks, or the like. Communication interface(s) 103 may be used to communicate with peripheral devices (e.g., Bluetooth® speakers, microphones, headsets, etc.). Moreover, communication interface(s) 103 may be coupled to chipset 102 via a Peripheral Component Interconnect Express (PCIe) bus, or the like.

Chipset 102 may be coupled to display and/or touchscreen controller(s) 104, which may include one or more Graphics Processor Units (GPUs) on a graphics bus, such as an Accelerated Graphics Port (AGP) or PCIe bus. As shown, display controller(s) 104 provide video or display signals to one or more display device(s) 105. Display device(s) 105 may include Liquid Crystal Display (LCD), Light Emitting Diode (LED), Organic LED (OLED), or other thin film display technologies. Display device(s) 105 may include a plurality of pixels arranged in a matrix, configured to display visual information, such as text, two-dimensional images, video, three-dimensional images, etc. In some cases, display device(s) 105 may be provided as a single continuous display, rather than two discrete displays.

Chipset 102 may provide host processor(s) 101 and/or display controller(s) 104 with access to system memory 106. In various embodiments, system memory 106 may be implemented using any suitable memory technology, such as static RAM (SRAM), dynamic RAM (DRAM) or magnetic disks, or any nonvolatile/Flash-type memory, such as a Solid-State Drive (SSD), Non-Volatile Memory Express (NVMe), or the like.

In certain embodiments, chipset 102 may also provide host processor(s) 101 with access to one or more Universal Serial Bus (USB) ports/controllers 107, to which one or more peripheral devices may be coupled (e.g., integrated or external webcams, microphones, speakers, etc.).

Chipset 102 may further provide host processor(s) 101 with access to a disk controller 108, which may include a disk interface that connects the disc controller 108 to a Hard Disk Drive (HDD), an Optical Disk Drive (ODD), an SSD, and/or a disk emulator. The disk interface may include, for example, an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. The disk emulator may be provide an external interface that permits one or more hard disk drives, solid-state drives, optical drives, or other removable-media drives to be connected to IHS 100. An example of external interface includes a USB interface, an IEEE 1394 (Firewire) interface, a proprietary interface, or a combination thereof.

Chipset 102 may also provide access to one or more user input devices 109, for example, using a super I/O controller or the like. Examples of user input devices 109 include, but are not limited to, microphone(s) 109a, camera(s) 109b, and/or keyboard/mouse 109c. Other user input devices 109 (not shown) may include a touchpad, stylus or active pen, totem, etc. Each user input device 109 may include a respective controller (e.g., a touchpad may have its own touchpad controller) that interfaces with chipset 102 through a wired or wireless connection, for example via communication interfaces(s) 103 and/or USB port(s) 107.

Microphone 109a may comprise any system, device, or apparatus configured to convert sound incident at microphone 109a to an electrical signal that may be processed by processor 101. In some embodiments, microphone 109a may include a capacitive microphone (e.g., an electrostatic microphone, a condenser microphone, an electret microphone, a microelectromechanical systems (MEMS) microphone, etc.) wherein such sound is converted to an electrical signal using a diaphragm or membrane having an electrical capacitance that varies as based on sonic vibrations received at the diaphragm or membrane.

In some cases, chipset 102 may also provide access to one or more output devices, such as an audio subsystem 110, speakers, headsets, video projectors, paper printers, 3D printers, Virtual/Augmented Reality (VR/AR) devices, etc. The output devices may be accessed, for example, via communication interfaces(s) 103 and/or USB port(s) 107. Audio subsystem 110 may include speakers, which comprise any system, device, or apparatus configured to produce sound in response to electrical audio signal input. In some embodiments, a speaker may comprise a dynamic loudspeaker, which employs a lightweight diaphragm mechanically coupled to a rigid frame via a flexible suspension that constrains a voice coil to move axially through a cylindrical magnetic gap such that when an electrical signal is applied to the voice coil, a magnetic field is created by the electric current in the voice coil, making it a variable electromagnet. The coil and the driver's magnetic system interact, generating a mechanical force that causes the coil (and thus, the attached cone) to move back and forth, thereby reproducing sound under the control of the applied electrical signal coming from the amplifier.

In certain embodiments, chipset 102 may further provide an interface for communications with one or more hardware sensors 111. Sensors 111 may be disposed on or within the chassis of IHS 100, or otherwise coupled to IHS 100, and may include, but are not limited to: electric, magnetic, radio, optical (e.g., camera, webcam, etc.), infrared, thermal, force, pressure, acoustic (e.g., microphone), ultrasonic, proximity, position, deformation, bending, direction, movement, velocity, rotation, gyroscope, Inertial Measurement Unit (IMU), and/or acceleration sensor(s).

A Basic Input and Output System/Unified Extensible Firmware Interface (BIOS/UEFI) 112 is coupled to chipset 102. UEFI was designed as a successor to BIOS, and many modern IHSs utilize UEFI in addition to or instead of a BIOS. Accordingly, BIOS/UEFI 112 is intended to also encompass a UEFI component. BIOS/UEFI 112 provides an abstraction layer that allows the OS to interface with certain hardware components that are utilized by IHS 100. Upon booting of IHS 100, host processor(s) 101 may utilize program instructions of BIOS 112 to initialize and test hardware components coupled to IHS 100, and to load a host OS for use by IHS 100. Via the hardware abstraction layer provided by BIOS/UEFI 112, software stored in system memory 106 and executed by host processor(s) 101 can interface with I/O devices coupled to IHS 100.

An Embedded Controller (EC) 113 (sometimes referred to as a Baseboard Management Controller or “BMC”) includes a microcontroller unit or processing core dedicated to handling selected IHS operations not ordinarily handled by host processor(s) 101. Examples of such operations may include, but are not limited to: power sequencing, power management, receiving and processing signals from a keyboard or touchpad, as well as other buttons and switches (e.g., power button, laptop lid switch, etc.), receiving and processing thermal measurements (e.g., performing cooling fan control, throttling CPUs and GPUs, controlling colling fan speeds, and emergency shutdown), controlling indicator Light-Emitting Diodes (LEDs) (e.g., caps lock, scroll lock, num lock, battery, ac, power, wireless LAN, sleep, etc.), managing the battery charger and the battery, enabling remote or Out-of-Band (OOB) management, diagnostics, and remediation over network(s), and the like.

Unlike other devices in IHS 100, EC 113 may be made operational from the very start of each power reset, before other devices are fully running or powered on. As such, EC 113 may be responsible for interfacing with a power adapter to manage the power consumption of IHS 100. These operations may be utilized to determine the power status of IHS 100, such as whether IHS 100 is operating from battery power or is plugged into an AC power source. Firmware instructions utilized by EC 113 may be used to manage other core operations of IHS 100 (e.g., turbo modes, maximum operating clock frequencies of certain components, etc.).

In some cases, EC 113 may implement operations for detecting certain changes to the physical configuration or posture of IHS 100 and managing other devices in different configurations of IHS 100. For instance, when IHS 100 as a 2-in-1 laptop/tablet form factor, EC 113 may receive inputs from a lid position or hinge angle sensor 111, and it may use those inputs to determine: whether the two sides of IHS 100 have been latched together to a closed position or a tablet position, the magnitude of a hinge or lid angle, etc. In response to these changes, the EC may enable or disable certain features of IHS 100 (e.g., front or rear facing camera, etc.).

In some implementations, EC 113 may be installed as a Trusted Execution Environment (TEE) component to the motherboard of IHS 100. Additionally, or alternatively, EC 113 may be further configured to calculate hashes or signatures that uniquely identify individual components of IHS 100. In such scenarios, EC 113 may calculate a hash value based on the configuration of a hardware and/or software component coupled to IHS 100. For instance, EC 113 may calculate a hash value based on all firmware and other code or settings stored in an onboard memory of a hardware component.

In addition, EC 113 may provide an Out-of-Band communication channel that allows an Information Technology Decision Maker (ITDM) or Original Equipment Manufacturer (OEM) to manage IHS 100's various settings and configurations, for example, by issuing OOB commands.

In various embodiments, IHS 100 may be coupled to an external power source through an AC adapter, power brick, or the like. The AC adapter may be removably coupled to a battery charge controller to provide IHS 100 with a source of DC power provided by battery cells of a battery system in the form of a battery pack (e.g., a lithium ion or “Li-ion” battery pack, or a nickel metal hydride or “NiMH” battery pack including one or more rechargeable batteries).

Battery Management Unit (BMU) 114 may be coupled to EC 113 and it may include, for example, an Analog Front End (AFE), storage (e.g., non-volatile memory), and a microcontroller. In some cases, BMU 114 may be configured to collect and store information, and to provide that information to other IHS components.

Examples of information collectible by BMU 114 may include, but are not limited to: operating conditions (e.g., battery operating conditions including battery state information such as battery current amplitude and/or current direction, battery voltage, battery charge cycles, battery state of charge, battery state of health, battery temperature, battery usage data such as charging and discharging data; and/or IHS operating conditions such as processor operating speed data, system power management and cooling system settings, state of “system present” pin signal), environmental or contextual information or state (e.g., such as ambient temperature, relative humidity, system geolocation measured by GPS or triangulation, time and date, etc.), events, etc. Examples of events may include, but are not limited to: acceleration or shock events, system transportation events, exposure to elevated temperature for extended time periods, high discharge current rate, combinations of battery voltage, battery current and/or battery temperature (e.g., elevated temperature event at full charge and/or high voltage causes more battery degradation than lower voltage), etc.

In some embodiments, IHS 100 may not include all the components shown in FIG. 1. Furthermore, some components that are represented as separate components in FIG. 1 may instead be integrated with other components, such that all or a portion of the operations executed by the illustrated components may instead be executed by the integrated component. For example, in various embodiments described herein, host processor(s) 101 and/or other components shown in FIG. 1 (e.g., chipset 102, display controller(s) 104, communication interface(s) 103, EC 113, etc.) may be replaced by other devices. As such, IHS 100 may assume different form factors including, but not limited to: servers, workstations, desktops, laptops, appliances, video game consoles, tablet computers, smartphones, etc.

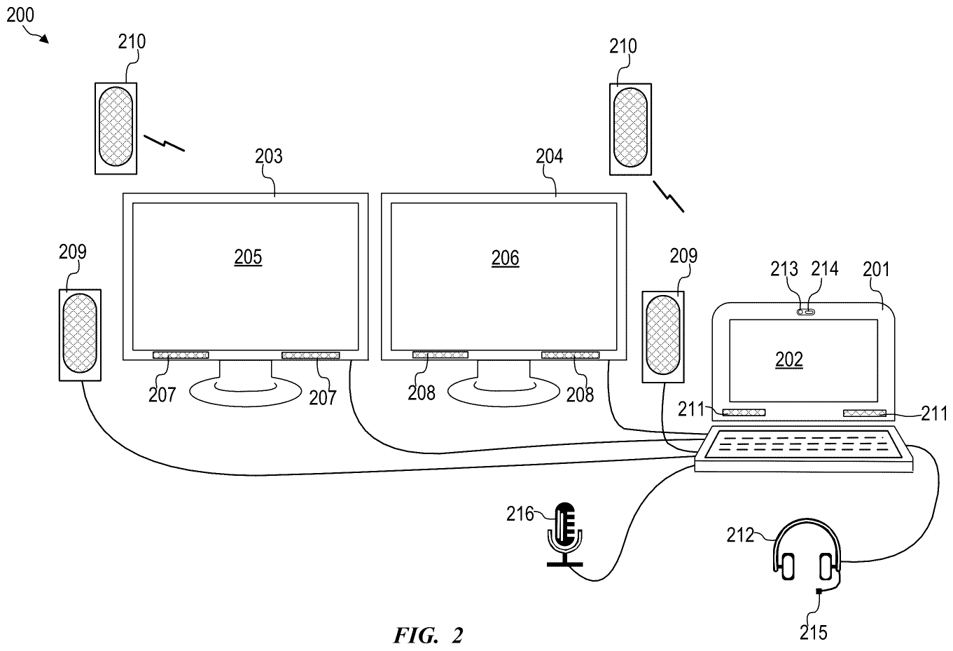

FIG. 2 illustrates an example embodiment of a workstation 200. An IHS 201, such as a laptop computer, has an architecture such as the embodiment shown in FIG. 1. IHS 201 may alternatively be a desktop computer, tablet computer, game console, or other device that supports multiple monitors. In the illustrated embodiment, laptop IHS 201 has a display screen 202 that is used to display applications and other content. IHS 201 is coupled to two external monitors 203, 204 having displays 205, 206, respectively. User interfaces and other visual content generated by applications running on IHS 201 may also be displayed on either or both external monitors 203, 204. Each monitor 203, 204 may have one or more speakers 207, 208, respectively. The monitors 203, 204 are connected to IHS 201 via a wired or wireless connection (e.g., HDMI cable, audio cable, Bluetooth® connection, etc.) that allows audio content from applications running on IHS 201 to be played over speakers 203 and/or 204.

IHS 201 is also connected to a first pair of external speakers 209 and a second pair of external speakers 210. Speakers 209, 210 may be connected to IHS 201 a wired or wireless connection (e.g., audio cable, Bluetooth® connection, etc.). Additionally, IHS 201 may have internal speakers 211. Other devices, such as headphone earphones 212 maybe connected to IHS 201 via a wired or wireless connection. Other types of audio playback devices, such as internal speakers, external speakers, soundbars, subwoofers, center-channel speakers, passive speakers, and active speakers may be connected to IHS 201.

Devices, such as IHS 201, using existing Operating Systems (OS), such as Windows 10, macOS, or Linux OS, determine which speakers to use based on a selected audio output device configuration. This may include a default output device wherein the OS assigns a default audio output device, such as built-in speakers, external speakers, headphones, Bluetooth devices, etc.), on which sounds are played. A user may manually select the preferred audio device in the OS sound settings. In some cases, built-in detection systems either in IHS hardware or the OS may prioritize external audio devices, such as speakers using an audio jack or a Bluetooth/USB connection. Audio drivers, such as software that interfaces between the OS and audio hardware, may also manage which speakers are used. Using currently available sound settings, IHS 201 selects only one audio playback device 207, 208, 209, 210, 211, or 212 to play audio content. Audio signals are routed directly to audio subsystem 110 for presentation by the selected audio playback device only. To use a different audio playback device in current systems, the user must select a new default audio playback device in the OS audio or sound settings.

In existing systems, the interface for applications running on IHS 201 may be presented on any of displays 202, 205, 206 and/or may be positioned so that they overlap multiple displays. Current OS audio management does not provide any positional properties based on application display. Instead, no matter which display is being used for an application, the sounds associated with that application will be broadcast over the selected output speaker.

The perceived location/source of sounds (such as audio created by applications or notifications generated by the OS) is based upon the selected default speakers. Generally, perceived location is in the “center” of the broadcast audio (i.e., between the selected pair of speakers). For example, if an application is displayed on monitor 203 but internal speakers 211 are selected, then any sounds generated by the application will be played over speakers 211. This will give the impression that the source of the sounds is on IHS display 202 even though the application is actually shown in a window on display 205. Therefore, in current systems, if multiple applications are presented in windows on different displays, the user cannot use audible cues to quickly find or identify the source of a notification.

IHS 201 may also be connected to one or more audio input devices, such as build-in and external microphones. IHS 201 may include an internal camera 213 and microphone 214 that allows the user to participate in video conferences or other communication sessions. In other configurations, an external camera with integrated microphone may be connected to IHS 201. Headset 212 may also include a microphone 215 that allows the user to communicate during a call or while gaming using headset 212. Alternatively, IHS 201 may be connected to a stand-alone external microphone 216, which may be a condenser, dynamic, or ribbon microphone depending upon the user's preference and the task requiring a microphone, such as public speaking and performances or studio recording of vocals and instruments. The external microphone 216 may be connected to IHS 201 using an audio cable, USB connection, or Bluetooth connection, for example.

The capabilities of various audio components, such as microphones and speakers, connected to an information handling system may differ. As an example, microphones 214, 215, 216 and speakers 207, 208, 209, 210, 211, and 212 may vary in their abilities to capture or generate sound at various volume levels and frequencies. Users of IHS 201 may want to utilize the full range of audio performance that is available from the system 200 but do not have the time or knowledge to configure the audio components. For example, the user may not understand the local sound environment (i.e., room or office acoustics) and may not want to go through the process of discovering all the potential inputs and outputs in the system 200 and then adjusting the components, such as balancing speaker positions, etc. Embodiments of the system and methods used by IHS 200 create a spatial audio atmosphere that is optimized for a user's current acoustic environment.

In an example embodiment, IHS 201 profiles the capabilities for all microphone inputs and speaker outputs that are identified in the system using an agent to setup and optimize the audio environment. This agent will have the one or more of the following characteristics and abilities: identify all microphones (e.g., microphone arrays) attached to the system, identify sensitivity and range parameters of the microphones, identify all speaker outputs attached to the system, and identify the range of each speaker output in terms of loudness (e.g., dB range) and frequency (e.g., response profile in Hz). The audio environment agent has the ability to profile the current acoustic environment (i.e., the room or space in which IHS 201 is located) by producing diagnostic sound waves that match the microphone/speaker profiles.

The audio environment agent transmits the highest and lowest possible frequencies capable of being generated by IHS 201 for each audio output (i.e., for each set of speakers). The audio environment agent uses the microphones to receive these signals and identifies occlusions, distortions, and echoes along with other acoustic characteristics of the audio environment. The audio environment agent also transmits white noise and/or other test audio signals in normal human hearing and speaking ranges to identify the occlusions, distortions, echoes and other acoustic characteristics. In one embodiment, a typical human voice frequency range is 85 Hz to 255 Hz, with men having a lower range approximately from 85 Hz to 155 Hz and women having a higher range approximately from 165Hz to 255 Hz.

The audio environment agent has the ability to alter the volume, pitch, and balance of the speaker outputs to optimize audio performance. In one embodiment, for example, the speaker outputs are optimized to present spatial separation (e.g., panning and stereo effects) for application audio content and system notification sounds.

The audio environment agent has the ability to set an audio profile for system notifications while leaving all other audio settings normal.

The audio environment agent has the ability to understand if changes to an audio setup/capability have occurred. For example, the audio environment agent may retest/reevaluate the acoustic environment each time IHS is rebooted, awoke from a sleep state, moved, or on demand by the user.

Current operating systems do not support such automatic acoustic setup for IHSs, such as laptop, desktop, or other computers. Existing operating systems are not capable of setting up a profile for system notifications such that only system notifications are targeted with an audio profile.

Existing systems do not have the ability to detect changes to speakers and microphones and automatically adjust and optimize the system's audio environment. Instead, in prior systems, speaker setup and profiling requires an external microphone setup and manual evaluating and updating of the acoustic environment.

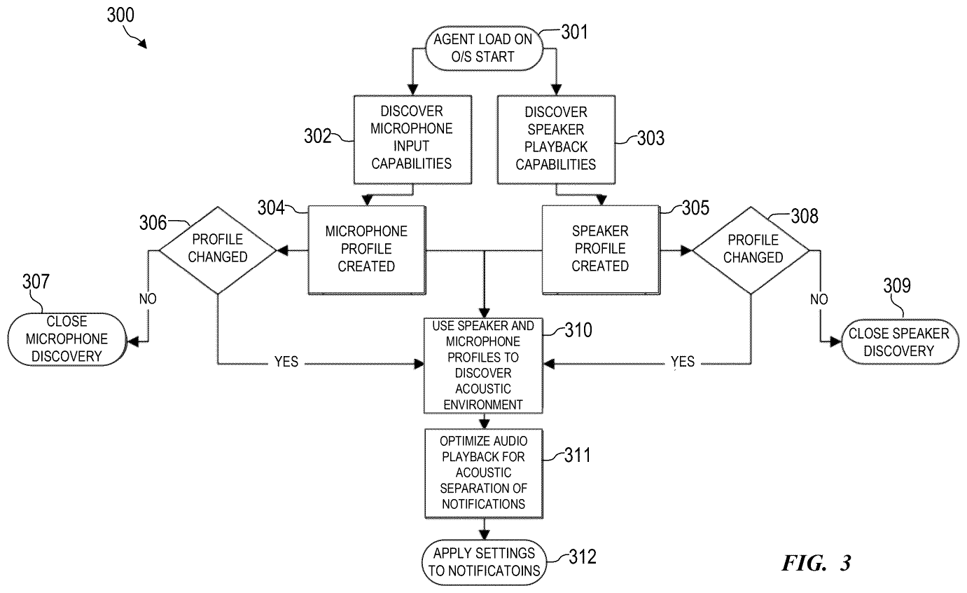

FIG. 3 is a flowchart 300 illustrating an example process for audio capability discovery in an IHS and for optimizing acoustic components in the IHS. At 301, an audio agent is loaded during the boot sequence of the IHS's operating system. The audio agent may be a module within the operating system code or may be a separate application running on the IHS under the control of the operating system. Once loaded, the audio agent begins discovery of microphone input capabilities at 302 and discovery of speaker playback capabilities at 303. The microphone and speaker discovery processes may occur simultaneously or may run sequentially with either process going first.

The microphone input capabilities are discovered at 302, for example, by playing test tones across a range of frequencies. The tones may be played by selected speakers attached to the IHS. The tones may be played by a single speaker, groups of speakers simultaneously, or by different individual speakers one at a time. At 304, a profile is created for each microphone attached to the IHS. Each microphone may be receiving the test tones at the same time for simultaneous evaluation of multiple microphones.

Similarly, the speaker playback capabilities may be discovered at 303 by playing the test tones across a range of frequencies. The tones may be played by selected speakers attached to the IHS one at a time so that each speaker can be evaluated independently. The IHS microphones may listen for the test tones one at a time or groups of microphones may listen for the test tones simultaneously. At 305, a profile is created for each speaker attached to the IHS.

The IHS stores the speaker and microphone profiles created at 304 and 305. This allows the IHS to identify changes in the capabilities of the audio subsystem components and changes in environmental acoustics. At 306, the IHS compares the current microphone profile to a previous microphone profile, such as a microphone profile created during a prior IHS boot up, or to an expected microphone profile, such as a profile published by a microphone's manufacturer. If there is no change or a minimal amount of change in the microphone profile, then the microphone discovery process is closed at 307.

At 308, the IHS compares the current speaker profile to a previous speaker profile, such as a speaker profile created during a prior IHS boot up, or to an expected speaker profile, such as a profile published by a speaker's manufacturer. If there is no change or a minimal amount of change in the speaker profile, then the speaker discovery process is closed at 309.

A minimal amount of change in a microphone or speaker profile may correspond to deviations between a current profile and a prior profile that are below a threshold amount. For example, if a current microphone or speaker profile is within five percent of a prior profile, then that profile may be close enough to prior profile to use settings associated with the prior profile.

Once the current profiles for the microphones and speakers have been created, the process uses the speaker and microphone profiles at 310 to discover the acoustic environment for the IHS. The IHS may profile the current acoustic environment by producing diagnostic sound waves that match the microphone and speaker profiles. The IHS may transmit the highest and lowest frequencies possible under the speaker profiles to identify occlusions, distortions, and echoes received by the microphones at those frequencies. The IHS may also transmit a white noise and/or other test audio signals in normal human hearing and speaking ranges to identify occlusions, distortions, and echoes at frequencies expected to require the most use.

Based upon the acoustic environment detected at 310, the IHS optimizes the audio playback to achieve acoustic separation of notifications at 311. For example, the IHS may alter the volume, pitch, and balance of speaker outputs to optimize notification spatial separation. The IHS may set the audio profile for notifications while leaving all other audio settings normal.

Audio spatial notification uses panning to control the audio output. Panning refers to distributing a stereo or mono audio signal throughout the left and right channels of a stereo field so that the “center” of the audio can be adjusted from side to side horizontally across a space or even vertically within the space. To provide the audio spatial notifications, the IHS uses the speaker profile and acoustic environment to control the playback of audio signals so that the sounds appear to come from a desired location within the room. In some embodiments, the notifications may be adjusted so that they appear to come from a particular display or display window (e.g., notification sounds appear on the left if a corresponding source of the notification is a screen, display, or application window on the left of the user. This provides a new method for mapping individual windows and displays to sound cues. The responsible display location is used to control the playing of audio notifications on particular speakers to increase the user's awareness of the location of the application window that originated the notification.

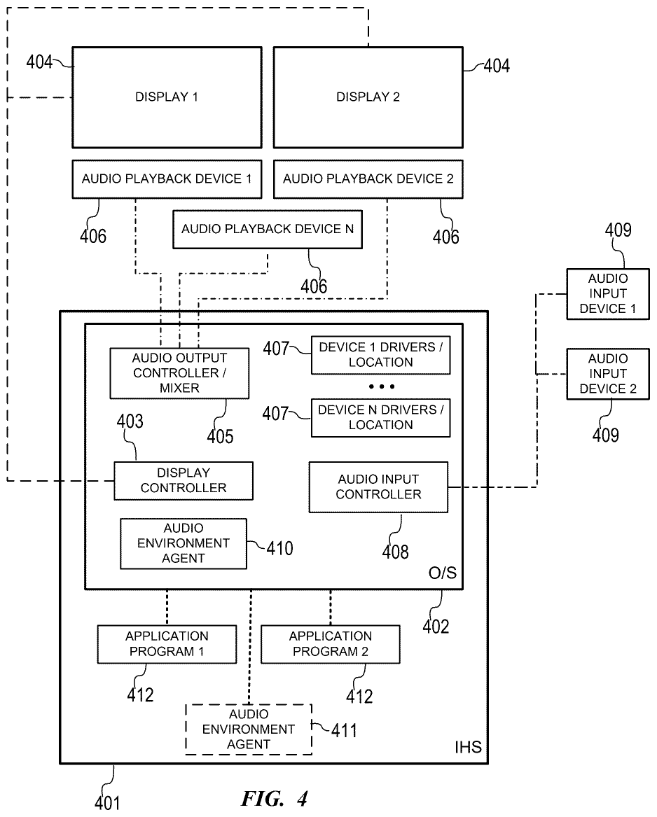

FIG. 4 is a block diagram illustrating components of a system for discovering audio capabilities for spatial notifications. IHS 401 has an operating system (OS) 402. A display controller module 403 in OS 402 is responsible for managing display content for one or more displays 404. An audio output controller/mixer 405 in OS 402 is responsible for managing audio content to be played on one or more audio playback device 406. Each of the audio playback devices 406 may be associated with a particular display 404 or may be an independent device, such as an external speaker, sound bar, headphones, etc.

The OS 402 maintains information regarding audio device drivers and location 407, which is associated with each of the audio playback devices 406. The audio device drivers and location 407 information may include, for example, the identity of a driver that should be loaded to use a particular audio playback devices 406 and/or the relative location of the audio playback devices 406. The location may identify a relative location of each audio playback device 406 compared to one or more of the displays 404. This may include, for example, whether the audio playback device 406 is co-located with (e.g., a component of) a particular display 406 and/or whether the audio playback device 406 is positioned left/right/above/below a particular display 406.

An audio input controller 408 manages audio input devices 409, such as microphones connected to IHS 401. An audio environment agent 410 is responsible for setting up and optimizing the audio environment for IHS 401. Audio environment agent 410 may perform a process, such as method 300 (FIG. 3), for audio capability discovery in IHS 401 and for optimizing the acoustic components. The audio environment agent may be a module 410 that is part of O/S 402 or the agent may be an application 411 that runs separate from O/S 402.

IHS 401 executes one or more application programs 412, such as productivity applications (e.g., word processing, spreadsheets, presentation software, and project management tools), web browsers, communication and collaboration tools (e.g., email clients, video conferencing, and messaging platforms), media and entertainment applications, development and coding tools, gaming applications, or other personal or professional applications. The application programs 412 generate display and audio content to be presented to users. The application programs 412 coordinate with OS 402 to provide the display and audio content to displays 404 and audio playback devices 406. Application programs 412 may also receive audio inputs via input devices 409.

Using the device driver and location information 407, the audio output controller/mixer 405 is capable of controlling multiple audio playback devices at the same time—unlike current systems in which the OS only controls one audio playback device at a time. Additionally, OS 402 is aware of how the display content for a particular application program is displayed (i.e., screen location and size) on displays 404. Using the location of the display content, audio output controller/mixer 405 can manage the associated audio content and provide audio modifications so that each audio signal can be presented with horizontal (left/right), vertical (high/low), and depth (layers of windows or tabs) panning.

In an example configuration, an Information Handling System (IHS) for providing audio spatial notifications comprises at least one processor configured to execute an operating system (OS) and one or more applications, including an audio environment agent. The agent is configured to identify all microphones and audio playback devices attached to the IHS, create profiles of the sensitivity and range of the microphones, create profiles of the range of the audio playback devices, produce diagnostic sound waves to identify acoustic characteristics of an environment near the IHS, and automatically alter one or more speaker output to modify audio within the environment.

The audio playback devices comprise one or more of: an internal speaker, an external speaker, a soundbar, a subwoofer, a center-channel speaker, headphones, a passive speaker, and an active speaker.

The diagnostic sound waves may comprise one or more of: high frequency signals, low frequency signals, and white noise.

The high frequency signals may be transmitted at a highest frequency possible for the speakers, the low frequency signals are transmitted at a lowest frequency possible for the speakers, and the white noise is broadcast in a frequency range between 85 Hz to 255 Hz.

The acoustic characteristics of the environment may comprise one or more of: occlusions, distortions, and echoes.

The speaker output may be altered by adjusting a volume, a pitch, or a balance of an audio signal sent to the speaker output.

The audio within the environment may be modified by removing occlusions, distortions, and echoes created by the environment.

The audio within the environment may be modified by adjusting system notifications transmitted to the speakers.

The audio within the environment may be modified by adjusting panning of system notifications transmitted to the speakers.

The one or more speaker output may be altered to modify system notifications while leaving other audio settings unmodified.

The agent may be further configured to compare the profiles of the create profiles the microphones and the audio playback devices to previously created microphone and speaker profiles.

In another configuration, a method for optimizing audio playback for notifications in an Information Handling System (IHS) comprises executing, by at least one processor, an operating system (OS) having an audio environment agent; identify all microphones and audio playback devices attached to the IHS; create, by the audio environment agent, sensitivity and range profiles for each of the identified microphones; create, by the audio environment agent, range profiles for each of the identified audio playback devices; produce diagnostic sound waves to discover an acoustic environment near the IHS; and modify audio signals sent to the audio playback devices to create an acoustic separation between notifications and other audio content.

The audio playback devices may comprise one or more of: an internal speaker, an external speaker, a soundbar, a subwoofer, a center-channel speaker, headphones, a passive speaker, and an active speaker.

The diagnostic sound waves may comprise one or more of: high frequency signals, low frequency signals, and white noise.

The high frequency signals may be transmitted at a highest frequency possible for the speakers, the low frequency signals are transmitted at a lowest frequency possible for the speakers, and the white noise is broadcast in a frequency range between 85 Hz to 255 Hz.

The acoustic characteristics of the environment may comprise one or more of: occlusions, distortions, and echoes.

The speaker output may be altered by adjusting a volume, a pitch, or a balance of an audio signal sent to the speaker output.

The audio within the environment may be modified by removing occlusions, distortions, and echoes created by the environment.

The audio within the environment may be modified by adjusting panning of system notifications transmitted to the speakers.

The one or more speaker output may be altered to modify system notifications while leaving other audio settings unmodified.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

What is claimed is:

1. An Information Handling System (IHS) for providing audio spatial notifications, comprising:
at least one processor configured to execute an operating system (OS) and one or more applications, including an audio environment agent, the agent configured to:
identify all microphones and audio playback devices attached to the IHS;
create profiles of the sensitivity and range of the microphones;
create profiles of the range of the audio playback devices;
produce diagnostic sound waves to identify acoustic characteristics of an environment near the IHS; and
automatically alter one or more speaker output to modify audio within the environment.

2. The IHS of claim 1, wherein the audio playback devices comprise one or more of: an internal speaker, an external speaker, a soundbar, a subwoofer, a center-channel speaker, headphones, a passive speaker, and an active speaker.

3. The IHS of claim 1, wherein the diagnostic sound waves comprise one or more of: high frequency signals, low frequency signals, and white noise.

4. The IHS of claim 3, wherein the high frequency signals are transmitted at a highest frequency possible for the speakers, the low frequency signals are transmitted at a lowest frequency possible for the speakers, and the white noise is broadcast in a frequency range between 85 Hz to 255 Hz.

5. The IHS of claim 1, wherein the acoustic characteristics of the environment comprise one or more of: occlusions, distortions, and echoes.

6. The IHS of claim 1, wherein the speaker output is altered by adjusting a volume, a pitch, or a balance of an audio signal sent to the speaker output.

7. The IHS of claim 1, wherein the audio within the environment is modified by removing occlusions, distortions, and echoes created by the environment.

8. The IHS of claim 1, wherein the audio within the environment is modified by adjusting system notifications transmitted to the speakers.

9. The IHS of claim 1, wherein the audio within the environment is modified by adjusting panning of system notifications transmitted to the speakers.

10. The IHS of claim 1, wherein the one or more speaker output is altered to modify system notifications while leaving other audio settings unmodified.

11. The IHS of claim 1, wherein the agent is further configured to:
compare the profiles of the create profiles the microphones and the audio playback devices to previously created microphone and speaker profiles.

12. A method for optimizing audio playback for notifications in an Information Handling System (IHS), comprising:
executing, by at least one processor, an operating system (OS) having an audio environment agent;
identify all microphones and audio playback devices attached to the IHS;
create, by the audio environment agent, sensitivity and range profiles for each of the identified microphones;
create, by the audio environment agent, range profiles for each of the identified audio playback devices;
produce diagnostic sound waves to discover an acoustic environment near the IHS; and
modify audio signals sent to the audio playback devices to create an acoustic separation between notifications and other audio content.

13. The method of claim 12, wherein the audio playback devices comprise one or more of: an internal speaker, an external speaker, a soundbar, a subwoofer, a center-channel speaker, headphones, a passive speaker, and an active speaker.

14. The method of claim 12, wherein the diagnostic sound waves comprise one or more of: high frequency signals, low frequency signals, and white noise.

15. The IHS of claim 14, wherein the high frequency signals are transmitted at a highest frequency possible for the speakers, the low frequency signals are transmitted at a lowest frequency possible for the speakers, and the white noise is broadcast in a frequency range between 85 Hz to 255 Hz.

16. The method of claim 12, wherein the acoustic characteristics of the environment comprise one or more of: occlusions, distortions, and echoes.

17. The method of claim 12, wherein the speaker output is altered by adjusting a volume, a pitch, or a balance of an audio signal sent to the speaker output.

18. The method of claim 12, wherein the audio within the environment is modified by removing occlusions, distortions, and echoes created by the environment.

19. The method of claim 12, wherein the audio within the environment is modified by adjusting panning of system notifications transmitted to the speakers.

20. The method of claim 12, wherein the one or more speaker output is altered to modify system notifications while leaving other audio settings unmodified.
